(19) United States
(12) Patent Application Publication
(10) Pub. No.: US 2023/0111528 A1
(43) Pub. Date: Apr. 13, 2023

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Takeshi Ozawa, Kanagawa (JP)

(21) Appl. No.: 18/045,085

(22) Filed: Oct. 7, 2022

(30) Foreign Application Priority Data
Oct. 11, 2021 (JP) 2021-166915

(51) Int. Cl. G06T 1/60; G06T 7/70

(52) U.S. Cl. CPC G06T 1/60; G06T 7/70; G06T 2207/30244

(57) ABSTRACT

An information processing apparatus comprises a storage control unit configured to convert information indicating an image capturing posture of a captured frame into posture information of posture expression without any discontinuity in posture change, and store compression encoded data of the frame and the posture information in a file.

### BACKGROUND OF THE DISCLOSURE

### Field of the Disclosure

The present disclosure relates to a technique for generating a file of compression encoded data.

### Description of the Related Art

In recent years, capturing a 360-degree omnidirectional video with a video camera and viewing the recorded video with a Head Mounted Display (HMD) or a smartphone, or viewing it as an omnidirectional video being projected in a manner surrounding the viewers are commonly performed. The video to be viewed can be compression encoded and stored as a moving image file according to the ISO Base File Format, the MP4 file format, or the like. Dynamic Adaptive Streaming over HTTP (MPEG-DASH) is known as an international standard for transmitting and stream-reproducing a moving image file of MP4 file format or the like over a network.

Viewing an omnidirectional video with an HMD requires a partial video corresponding to a direction in which the viewer turns the HMD and a viewing angle to be appropriately selected from the omnidirectional video and reproduced by the HMD. The HMD constantly monitors the viewer’s viewing posture using a tilt sensor and cuts out a video as appropriate based on the viewing posture detected during the monitoring. Generally, the posture can be expressed using the Euler angles, quaternion, or direction cosine matrix. Although the Euler angles formed of three angles from orthogonal coordinate axes provides an advantage that it is easy to intuitively recognize the posture at a point of time, it may also incur intermittence that may occur in the direction of the video being displayed when the posture changes in an unconstrained manner. Accordingly, a quaternion being free of the intermittence circumstance is used more frequently for posture expression in the HMD, despite that each quaternion is formed of four coefficients and may lead to an increased number of parameters.

On the other hand, nowadays there is a demand for an image-capturing mode, as the image-capturing mode for omnidirectional video, such as hand-held shooting or capturing by a video camera mounted on a drone (unmanned plane) without any constraint such that the video camera must be secured or the movement of the video camera must be precisely controlled while capturing. However, when there is movement in the posture of the video camera while capturing, selecting a region (viewing region), in the omnidirectional video, being viewed by a viewer solely from posture information of the viewer using an HMD may cause a viewing region to be selected without considering the posture of a video camera while capturing. In such case, causing the HMD to acquire posture information of the video camera while capturing and select a viewing region considering the posture information allows for selecting an appropriate viewing region. Japanese Patent No. 6599436 discloses a method of using, when viewing a video, posture information acquired while capturing.

Conventional techniques have proposed methods that use angle information such as the Euler angles for expressing posture information while capturing. However, as has been described above, the Euler angles has an intrinsic issue of occurrence of intermittence in the direction of the video being displayed when the video is captured with the posture freely and continuously changing. In addition, it is often the case to use a quaternion or a direction cosine matrix for posture expression in the HMD and, when the posture information while capturing is expressed by the Euler angles, a conversion process is required to convert the Euler angles into a quaternion or a direction cosine matrix. However, reproducing a video in the HMD accompanies a decoding process of the video, and therefore additionally performing such a conversion process for each frame generates significant cost.

### SUMMARY OF THE DISCLOSURE

The present disclosure provides a technique for generating, for each frame in a video, a file that facilitates efficient acquisition of posture information, expressed by a posture expression without any discontinuity in posture change, with the frame.

According to the first aspect of the present disclosure, there is provided an information processing apparatus comprising a storage control unit configured to convert information indicating an image capturing posture of a captured frame into posture information of posture expression without any discontinuity in posture change, and store compression encoded data of the frame and the posture information in a file.

Further features of the present disclosure will become apparent from the following description of exemplary embodiments with reference to the attached drawings.

### BRIEF DESCRIPTION OF THE DRAWINGS

FIG. 1 is a diagram illustrating an example of an image capturing apparatus;

FIG. 2 is a block diagram illustrating an exemplary functional configuration of an image capturing apparatus;

FIG. 3 illustrates an example of quaternion posture information in chronological order;

FIG. 4A is a diagram illustrating a configuration example of an MP4 file;

FIG. 4B is a diagram illustrating a configuration definition example of a stra Box;

FIG. 5A is a flowchart of a process performed by a generation unit;

FIG. 5B is a flowchart of a process performed by the generation unit;

FIG. 6A is a diagram illustrating a configuration example of the stra Box;

FIG. 6B is a diagram illustrating a configuration example of the stra Box;

FIG. 7A is a diagram illustrating another configuration example of the stra Box;

FIG. 7B is a diagram illustrating another configuration example of the stra Box;

FIG. 8 illustrates is a diagram illustrating a configuration example of the stra Box;

FIG. 9 is a diagram illustrating a configuration example of the stra Box;

FIG. 10 is a diagram illustrating a configuration example of the stra Box;

FIG. 11 is a flowchart of a process performed by the generation unit;

FIG. 12 is a diagram illustrating a configuration example of the stra Box; and

FIG. 13 is a block diagram illustrating a hardware configuration example of a computer apparatus.

### DESCRIPTION OF THE EMBODIMENTS

Hereinafter, embodiments will be described in detail with reference to the attached drawings. Note, the following embodiments are not intended to limit the scope of the present disclosure. Multiple features are described in the embodiments, but limitation is not made a disclosure that requires all such features, and multiple such features may be combined as appropriate. Furthermore, in the attached drawings, the same reference numerals are given to the same or similar configurations, and redundant description thereof is omitted.

### First Embodiment

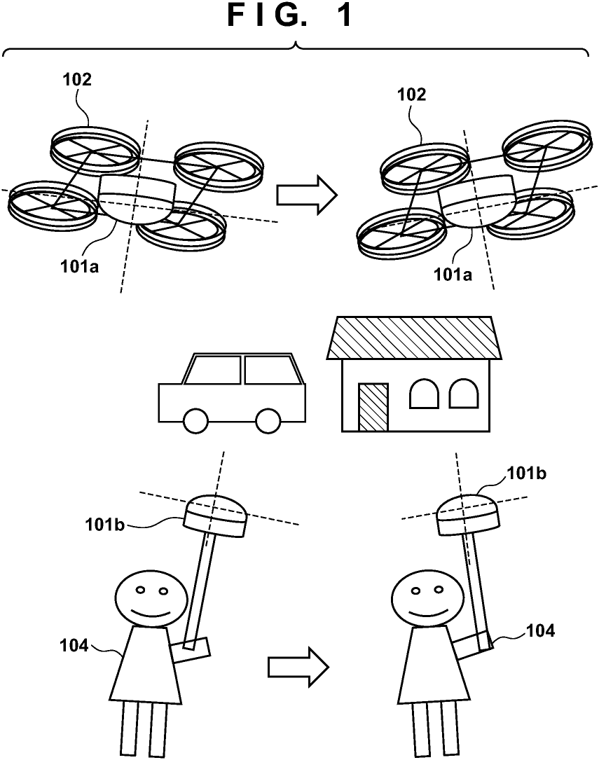

The present embodiment describes an example of an information processing apparatus configured to convert information indicating an image capturing posture of a captured frame into posture information of posture expression without any discontinuity in posture change, and store (store and control) compression encoded data of the frame and the posture information in a file. The present embodiment describes an image capturing apparatus which can capture a video (moving image) in all directions (omnidirectional video) as an example of such an information processing apparatus. The image capturing apparatus according to the present embodiment encodes, and stores in a file, each frame (captured image) in the captured video, as well as converts information indicating posture of the image capturing apparatus at the time of capturing the frame into posture information of posture expression without any discontinuity in posture change and stores the posture information in the file. An example of such an image capturing apparatus is illustrated in FIG. 1.

An image capturing apparatus 101a, which is mounted on a drone 102, can capture an omnidirectional video in various postures by a user operating a controller to control the flight of the drone 102. FIG. 1 illustrates a state in which the drone 102 is moving from left to right as indicated by an arrow with the image capturing apparatus 101a mounted thereon, and is performing image capturing while changing the posture of the image capturing apparatus 101a.

An image capturing apparatus 101b is a hand-held camera held by a user 104, and the image capturing apparatus 101b can capture an omnidirectional video in various postures by the user changing the posture of the image capturing apparatus 101b that is a hand-held camera. FIG. 1 illustrates a state in which the user 104 is moving from left to right as indicated by an arrow and is performing image capturing while changing the posture of the image capturing apparatus 101b.

As such, there are various methods for capturing an omnidirectional video while changing the posture of the image capturing apparatus, and the present embodiment does not limit the method for capturing an omnidirectional video in various postures to any specific method.

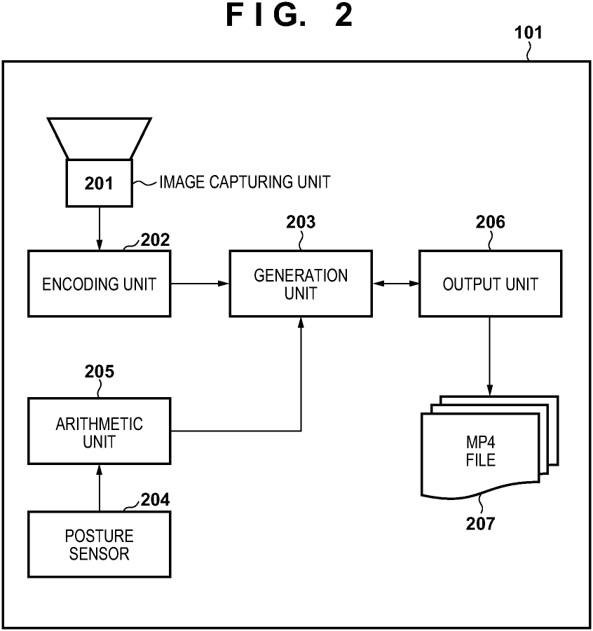

Next, there will be described a hardware configuration example of the image capturing apparatus 101 according to the present embodiment (an image capturing apparatus also applicable to the image capturing apparatus 101a and the image capturing apparatus 101b described above), referring to the block diagram of FIG. 2. Description will be provided below, assuming that each of the functional units illustrated in FIG. 2 is implemented by hardware.

An image capturing unit 201, which can capture an omnidirectional video, outputs the captured omnidirectional video as omnidirectional video data. An encoding unit 202 compression encodes the omnidirectional video data output from the image capturing unit 201 with a video encoding scheme such as H0.264 or H0.265.

A posture sensor 204 detects its own posture as a posture of the image capturing apparatus 101 and outputs information indicating the detected posture as detected posture information. Here, when operating in synchronization with the image capturing unit 201, the posture sensor 204 detects a posture of the image capturing apparatus 101 at the time of capturing each frame by the image capturing unit 201. In addition, the posture sensor 204 detects a posture of the image capturing apparatus 101 near the time of capturing each frame by the image capturing unit 201, when asynchronously operating with the image capturing unit 201.

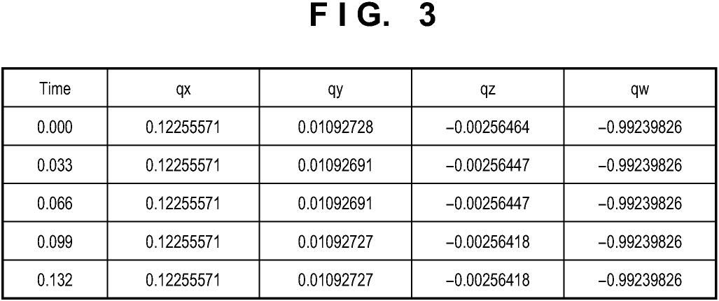

An arithmetic unit 205 converts the detected posture information output from the posture sensor 204 into “quaternion posture information”, which is an example of “posture information of posture expression without any discontinuity in posture change”. The posture sensor 204 detects posture continuously (regularly or irregularly), and the arithmetic unit 205 converts the detected posture information of each posture continuously detected by the posture sensor 204 into quaternion posture information. FIG. 3 illustrates an example of quaternion posture information in chronological order, acquired by the arithmetic unit 205.

FIG. 3 illustrates posture information (values of a quaternion qx, qy, qz, qw) acquired by the arithmetic unit 205 for postures detected at respective time points, that is Time = 0.000, 0.033, 0.066, 0.099, 0.132. Each of the values of the quaternion qx, qy, qz and qw satisfies - 1 < qk ≤ 1 (k = x, y, z, w).

A generation unit 203 generates an MP4 file formatted file as an MP4 file 207 including the compression encoded data generated by the compression encoding performed by encoding unit 202 and the quaternion posture information generated by the conversion performed by the arithmetic unit 205. On this occasion, the generation unit 203 stores a sample (frame), for each sample treated as a unit of compression encoded data to be decoded, in the MP4 file 207 together with the quaternion posture information of the image capturing apparatus 101 at the time of capturing the sample.

An output unit 206 outputs the MP4 file 207 generated by the generation unit 203. The output destination of the MP4 file 207 from the output unit 206 is not limited to any specific output destination. For example, the output unit 206 may transmit the MP4 file 207 to an external apparatus via a wired or wireless network, or store the MP4 file 207 in a memory apparatus included in the image capturing apparatus 101 or inserted to the image capturing apparatus 101.

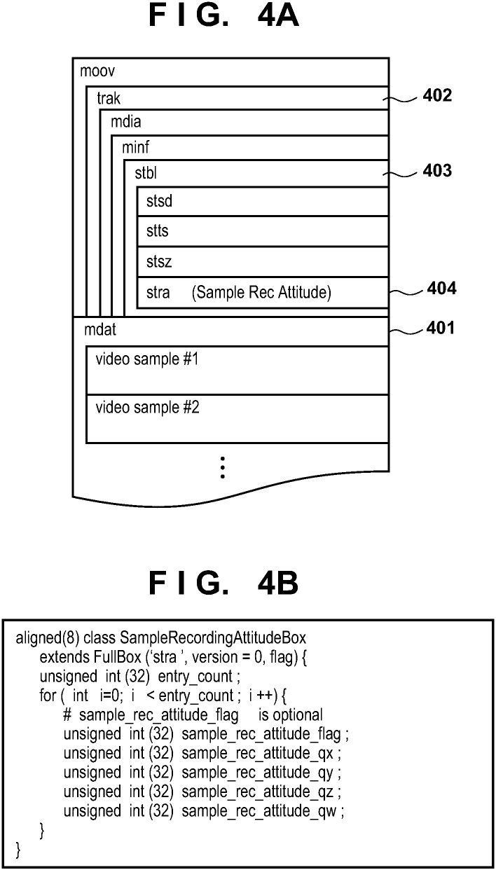

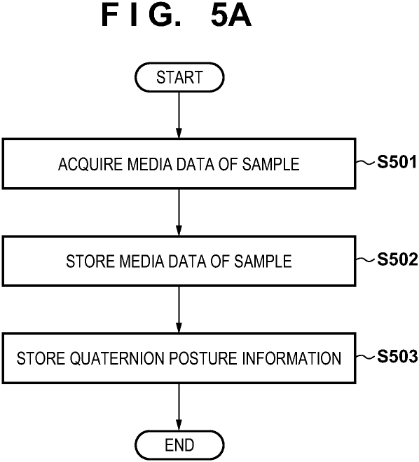

FIG. 4A illustrates a configuration example of the MP4 file 207; A file according to the ISO Base File Format or the MP4 file format is structured as illustrated in FIG. 4A, and therefore media data such as compression encoded data of a video are stored in an mdat Box 401. Furthermore, reproduction information of the media data is stored as a media truck in a trak Box 402 of the header information. The trak Box 402 includes a stbl Box 403 having information arranged as a table of each sample treated as a unit of media data to be decoded, in which reproduction time and data length of each sample are stored.

In the present embodiment, the stra Box 404 for storing posture information for each sample in the stbl Box 403 is defined. A configuration definition example of the stra Box 404 is illustrated in FIG. 4B.

In FIG. 4B, the stra Box 404 is defined as a SampleRecordingAttitudeBox, and a flag Field having a value of statistically defined bit sum stored therein indicates that the posture information is in the form of a quaternion.

A method for describing the posture information data in the flag field includes describing absence or presence of individual flag for each sample, posture information data length, absolute value or difference value of posture information. The posture information data is stored as array data for respective samples of a number of an entry_count, and includes storage fields of a flag and quaternion posture information (qx, qy, qz, qw) being defined for each sample. It is assumed here that the flag is single-bit information indicating that the posture information of the sample is present or absent (1:present, 0:absent).

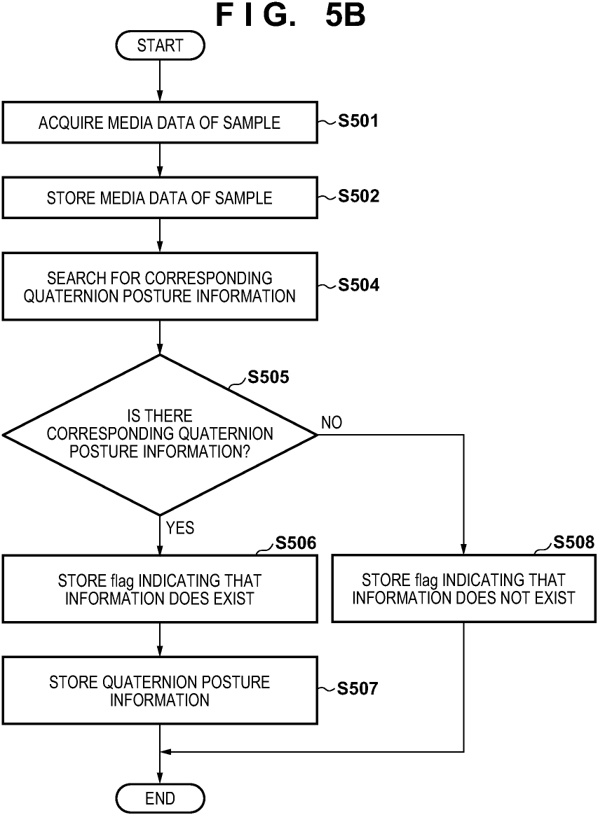

There will be described a process performed by the generation unit 203 to store one sample (one frame) of media data and posture information in the MP4 file 207 according to a flowchart illustrated in FIG. 5A. By performing a process according to the flowchart illustrated in FIG. 5A for each captured frame, the image capturing apparatus 101 stores, in the MP4 file 207, compression encoded data of the frame and quaternion posture information of the image capturing apparatus 101 at the time of capturing the frame.

It is assumed in the flowchart illustrated in FIG. 5A that a flag common to all the samples is stored in the MP4 file 207, instead of storing a flag for each sample in the MP4 file 207. In other words, a single flag indicating “1” for all the samples will be stored in the MP4 file 207, assuming that posture information is obtained for all the samples.

At step S501, the generation unit 203 acquires media data of a sample (compression encoded data of a sample) from the encoding unit 202. At step S502, the generation unit 203 stores the media data of the sample acquired at step S501 in the mdat Box 401 of the MP4 file 207. At step S503, the generation unit 203 stores, in the stra Box 404 of the MP4 file 207, the quaternion posture information for the sample acquired from the arithmetic unit 205.

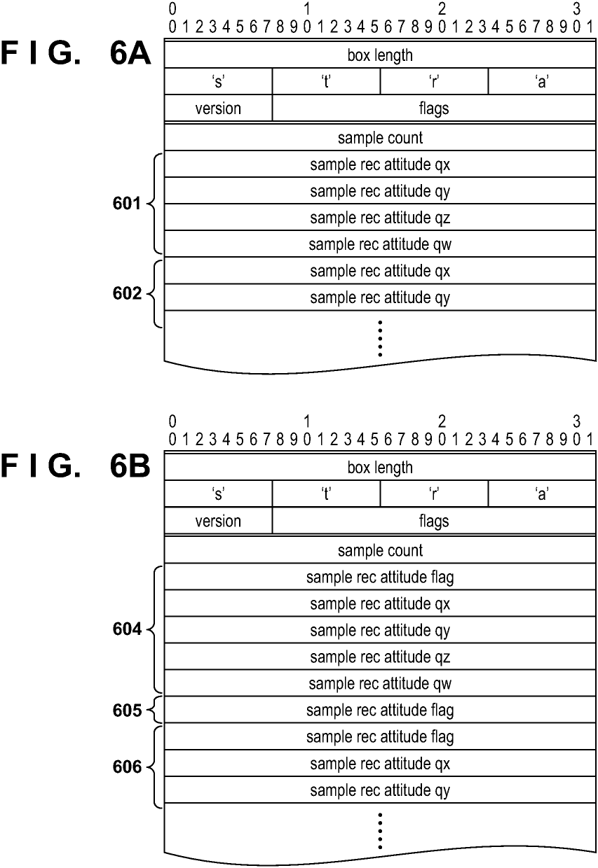

FIG. 6A illustrates a configuration example of the stra Box 404 of the MP4 file 207. In FIG. 6A, fields 601 and 602 are fields for respectively storing quaternion posture information for a single sample, and for storing qx, qy, qz and qw as 4-byte length data.

As such, in the present embodiment, an image capturing posture of a frame is converted into quaternion posture information and stored in a file for storing compression encoded data of each captured frame. Accordingly, no matter how the HMD has rotated, the HMD can acquire, in a frame-by-frame manner, appropriate “posture information of posture expression without any discontinuity in posture change” which is appropriate as a “image capturing posture” required for determining a video region to be cut out. In addition, conversion into quaternion posture information is not required when reproducing a video, whereby the processing load during reproduction can be reduced.

### Second Embodiment

In the following embodiments including the present embodiment, difference from the first embodiment will be described, assuming that the following embodiments are similar to the first embodiment unless otherwise specified. In the first embodiment, the posture sensor 204 being assumed to operate in synchronization with the image capturing unit 201, quaternion posture information for each sample can be acquired, and therefore the quaternion posture information for each sample is stored in the MP4 file 207.

In contrast, it is assumed in the present embodiment that the posture sensor 204 asynchronously operates with the image capturing unit 201. There is a possibility in this occasion that the posture sensor 204 does not perform posture detection at a timing within a defined range from the capturing timing and, in such a case, quaternion posture information corresponding to a frame cannot be acquired.

There will be described a process performed by the generation unit 203 to store one sample (one frame) of media data and posture information in the MP4 file 207 according to a flowchart illustrated in FIG. 5B. As with FIG. 5A, the process according to the flowchart illustrated in FIG. 5B is also performed for each frame captured by the image capturing apparatus 101. In FIG. 5B, process steps similar to those process steps illustrated in FIG. 5A are provided with similar step numbers, and explanation relating to the process steps is omitted.

At step S504, the generation unit 203 searches, from a set of quaternion posture information previously acquired by the arithmetic unit 205, quaternion posture information corresponding to the detected posture information detected by the posture sensor 204 at a timing within a certain range from the sample capturing timing.

When, as a result of the search, quaternion posture information corresponding to the detected posture information detected by the posture sensor 204 at a timing within a certain range from the sample capturing timing is found from the set of quaternion posture information previously acquired by the arithmetic unit 205, the process proceeds to step S506.

When, on the other hand, quaternion posture information corresponding to the detected posture information detected by the posture sensor 204 at a timing within a certain range from the sample capturing timing is not found from the set of quaternion posture information previously acquired by the arithmetic unit 205, the process proceeds to step S508.

At step S506, the generation unit 203 stores a flag indicating that “the quaternion posture information is found by the search” (posture information of the sample exists) in the MP4 file 207. At step S507, the generation unit 203 stores the quaternion posture information, found by the search, in the stra Box 404 of the MP4 file 207.

On the hand, at step S508, the generation unit 203 stores a flag indicating that “the quaternion posture information is not found by the search” (posture information of the sample does not exist) in the MP4 file 207.

FIG. 6B illustrates a configuration example of the stra Box 404 of the MP4 file 207 generated as described above. Fields 604 and 606 are fields respectively storing the flag indicating that “the quaternion posture information is found by the search” (posture information of the sample exists), and the quaternion posture information (qx, qy, qz, qw) detected by the search. A field 605 is a field storing the flag indicating that “the quaternion posture information is not found by the search” (posture information of the sample does not exist).

### Third Embodiment

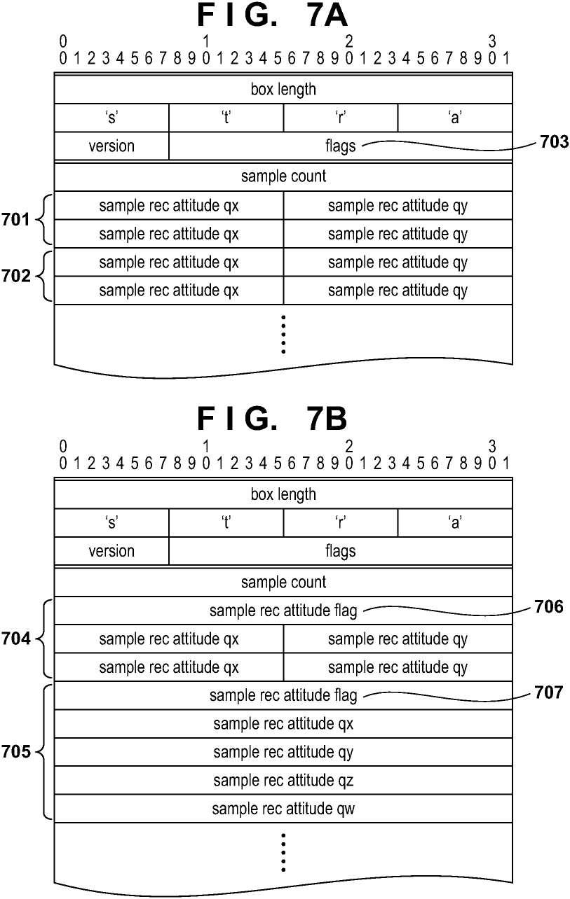

FIG. 7A illustrates another configuration example of the stra Box 404 of the MP4 file 207. The stra Box 404 illustrated in FIG. 7A is storing therein each of the quaternion posture information qx, qy, qz and qw as 2-byte length data. This is intended to realize efficient data storage in the stra Box 404 by shortening the data length when the posture detection accuracy is low.

Fields 701 and 702 respectively have stored therein posture information in a shorter data length than that of the embodiment described above. Presence or absence of data length compression can be determined according to a flags field 703. As such, the data length of posture information may be commensurate with the posture detection accuracy.

FIG. 7B illustrates another configuration example of the stra Box 404 of the MP4 file 207. In the stra Box 404 illustrated in FIG. 7B, the data length of the quaternion posture information qx, qy, qz and qw are variable for each sample. A field 704 has stored therein posture information as 2-byte length data, and a field 705 has stored therein posture information as 4-byte length data. A flag field 706 in the field 704 has set therein a bit flag that enables determination of the byte length of the posture information stored in the field 704. Similarly, a flag field 707 in the field 705 has set therein a bit flag that enables determination of the byte length of the posture information stored in the field 705.

### Fourth Embodiment

In the present embodiment, there will be described several configuration examples of the stra Box 404 to be stored with “difference of quaternion posture information between samples (between frames)”. However, the configurations described below are merely exemplary, and by no means intended to limit the present disclosure to the configurations described below.

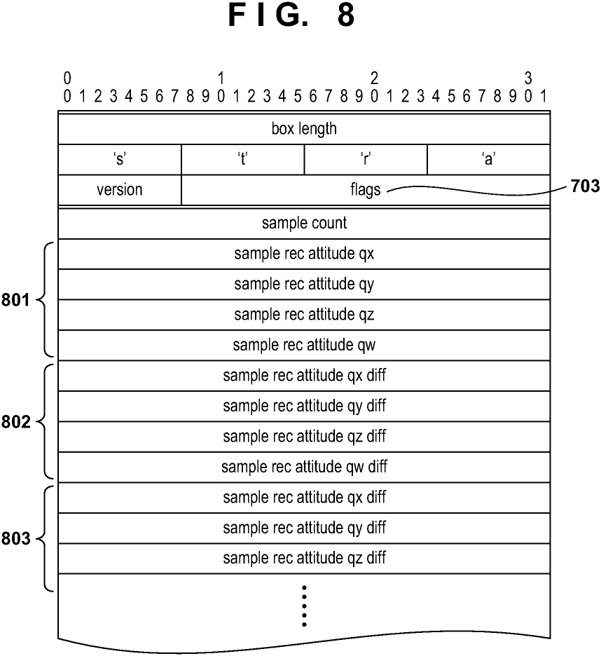

A configuration example of the stra Box 404 is illustrated in FIG. 8. In the configuration illustrated in FIG. 8, “difference of quaternion posture information between samples” is stored in the stra Box 404 as 4-byte (fixed length) data.

A field 801 is a field corresponding to a first sample, and is stored therein the absolute value of qx, qy, qz and qw corresponding to the first sample. A field 802 is a field corresponding to a second sample, and is stored therein respective differences between qx, qy, qz and qw corresponding to the first sample and qx, qy, qz and qw corresponding to the second sample.

A field 803 is a field corresponding to a third sample, and is stored therein respective differences between qx, qy, qz and qw corresponding to the second sample and qx, qy, qz and qw corresponding to the third sample.

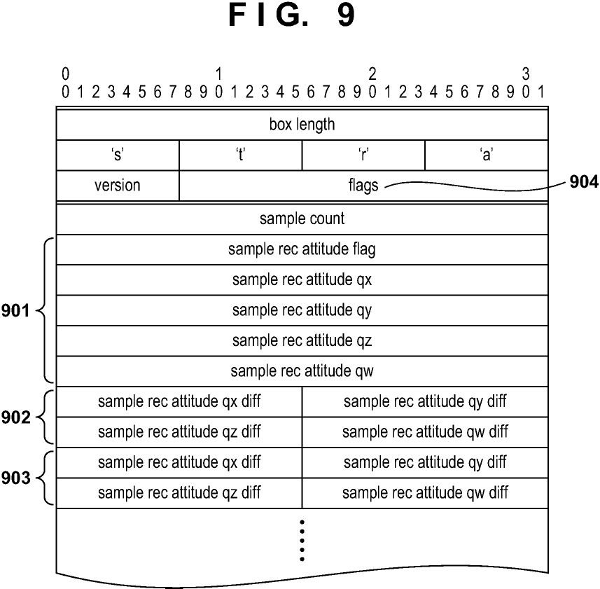

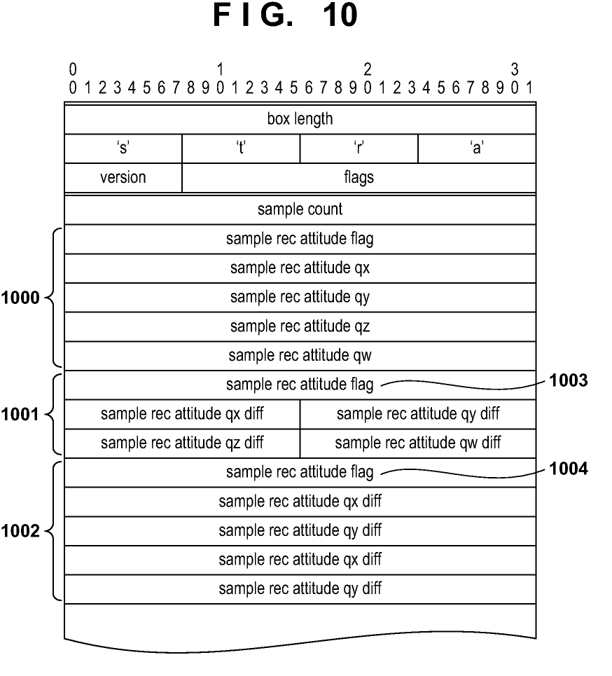

A configuration example of the stra Box 404 is illustrated in FIG. 9. In the configuration illustrated in FIG. 9, “difference of quaternion posture information between samples” is stored in the stra Box 404 as 2-byte (fixed length) data.

A field 901 is a field corresponding to the first sample, and is stored therein the absolute value of qx, qy, qz and qw corresponding to the first sample and a flag indicating that the field 901 is a field storing the absolute value.

A field 902 is a field corresponding to the second sample, and is stored therein respective differences between qx, qy, qz and qw corresponding to the first sample and qx, qy, qz and qw corresponding to the second sample.

A field 903 is a field corresponding the third sample, and is stored therein respective differences between qx, qy, qz and qw corresponding to the second sample and qx, qy, qz and qw corresponding to the third sample.

Using the difference value instead of the absolute value provides an effective configuration when a short data length is sufficient. It is determined, by the bit flag set in flags field 904, that the quaternion posture information corresponding to the second and subsequent samples is the “difference of quaternion posture information from a preceding sample” and the data length is 2 bytes.

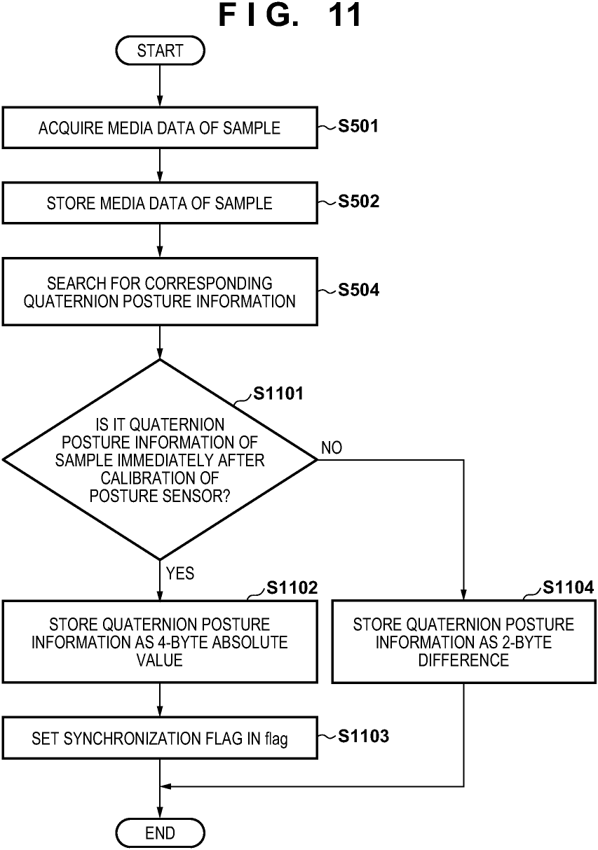

A configuration example of the stra Box 404 is illustrated in FIG. 10. In the configuration illustrated in FIG. 10, “difference of quaternion posture information between samples” is stored in the stra Box 404 as data with variable length.

A field 1000 is a field corresponding to the first sample, is stored therein the absolute value of qx, qy, qz and qw corresponding to the first sample, and a flag indicating that the field 1000 is a field storing the absolute value.

A field 1001 is a field corresponding to the second sample, and is stored therein, as 2-byte data, respective differences between qx, qy, qz and qw corresponding to the first sample and qx, qy, qz and qw corresponding to the second sample. The byte length of the difference is indicated in a flag field 1003.

A field 1002 is a field corresponding to the third sample, and is stored therein, as 4-byte data, respective differences between qx, qy, qz and qw corresponding to the second sample and qx, qy, qz and qw corresponding to the third sample. The byte length of the difference is stored in a flag field 1004.

### Fifth Embodiment

In the present embodiment, quaternion posture information corresponding to a sample (first sample) immediately after having performed calibration of the posture sensor 204 is stored in the stra Box 404 as 4-byte data representing absolute value of the posture information. Subsequently, quaternion posture information corresponding to an N-th (N being an integer equal to or larger than 2) sample is stored in the stra Box 404 as 2-byte data representing the difference from the quaternion posture information corresponding to an (N - 1)-th sample.

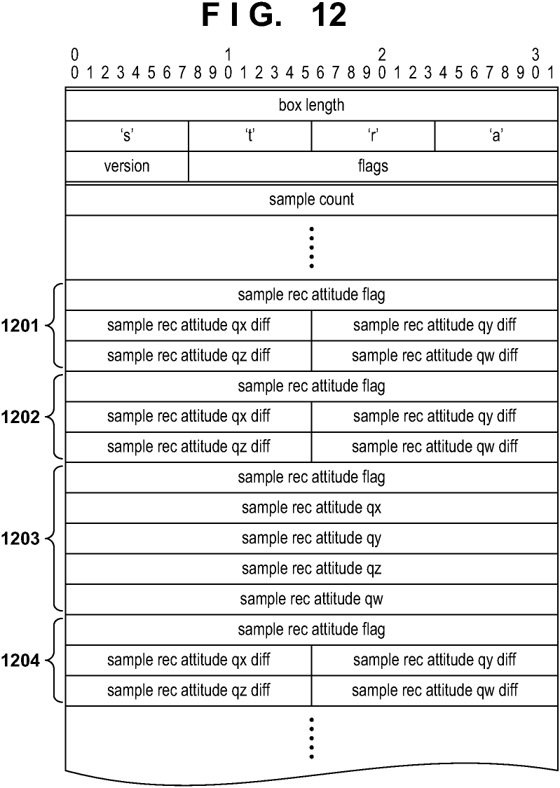

There will be described a process performed by the generation unit 203 to store one sample (one frame) of media data and posture information in the MP4 file 207 according to a flowchart illustrated in FIG. 11. The process according to the flowchart of FIG. 11 is also performed for each frame captured by the image capturing apparatus 101. In FIG. 11, process steps similar to those process steps illustrated in FIGS. 5A and 5B are provided with similar step numbers, and explanation relating to the process steps is omitted.

At step S1101, the generation unit 203 determines whether or not the quaternion posture information acquired from the arithmetic unit 205 is the quaternion posture information of a sample immediately after having performed calibration of the posture sensor 204. When, as a result of the determination, the quaternion posture information acquired from the arithmetic unit 205 is the quaternion posture information of a sample immediately after having performed calibration of the posture sensor 204, the process proceeds to step S1102. When, on the other hand, the quaternion posture information acquired from the arithmetic unit 205 is not the quaternion posture information of a sample immediately after having performed calibration of the posture sensor 204, the process proceeds to step S1104.

At step S1102, the generation unit 203 stores the absolute value of the quaternion posture information acquired from the arithmetic unit 205 in the stra Box 404 of the MP4 file 207 as 4-byte data. At step S1103, the generation unit 203 sets a synchronization flag in a flag field corresponding to a sample immediately after having performed calibration of the posture sensor 204.

On the other hand, at step S1104, the generation unit 203 stores the difference between the quaternion posture information acquired from the arithmetic unit 205 and the quaternion posture information corresponding to the preceding sample in the stra Box 404 of the MP4 file 207 as 2-byte data.

The reproduction apparatus configured to reproduce the MP4 file 207 described above uses posture information corresponding to the flag field, including the synchronization flag, as it is. On the other hand, for a sample of interest corresponding to a flag field which does not include the synchronization flag, the reproduction apparatus adds the posture information (difference) of the sample of interest and restored posture information of a sample preceding the sample of interest to restore the posture information of the sample of interest, and uses the restored posture information.

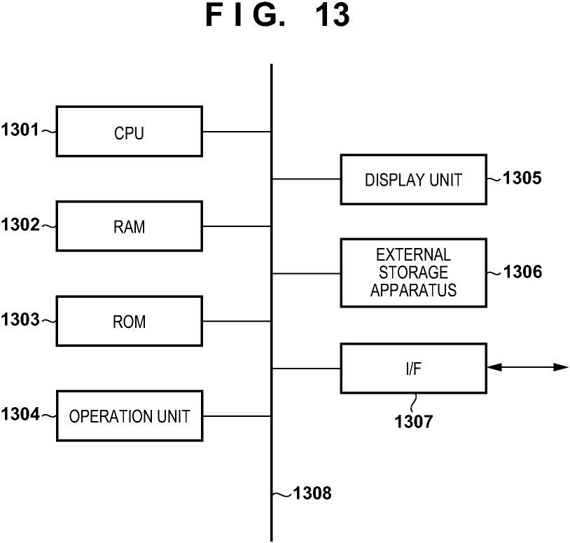

A configuration example of the stra Box 404 generated according to the flowchart of FIG. 11 is illustrated in FIG. 12. Fields 1201, 1202 and 1204 are fields for storing 2-byte data representing the difference between the quaternion posture information corresponding to a sample which is not the sample immediately after calibration of the posture sensor 204 and the posture information of the preceding sample.

A field 1203 is a field for storing, as 4-byte data, the absolute value of the quaternion posture information corresponding to a sample immediately after calibration of the posture sensor 204.

### Sixth Embodiment

Although “quaternion posture information” has been used in the embodiments described above as an example of “posture information of posture expression without any discontinuity in posture change”, other information such as a direction cosine matrix may also be used as the “posture information of posture expression without any discontinuity in posture change”.

In addition, although the image capturing unit 201 has been described to collect only video in the embodiments described above, sound may also be collected in addition to video. In such a case, compression encoded data of each frame and compression encoded data of sound corresponding to each frame are stored in the MP4 file 207.

Although the function units illustrated in FIG. 2 have been described to be implemented by hardware in the embodiments described above, the encoding unit 202, the arithmetic unit 205, the generation unit 203, and the output unit 206 may be implemented by software (computer programs). In such a case, the computer apparatus that can execute such a computer program can be applied to the image capturing apparatus 101.

In addition, the information processing apparatus described above can also be applied to an apparatus including the encoding unit 202, the arithmetic unit 205, the generation unit 203, and the output unit 206, with the image capturing unit 201 and the posture sensor 204 being connected thereto as external apparatuses. Although the encoding unit 202, the arithmetic unit 205, the generation unit 203, the output unit 206 may also be implemented by hardware in such a case, they may be implemented by software and, in the latter case, such a computer apparatus that can execute such a computer program can be applied to an information processing apparatus. A hardware configuration example of such a computer apparatus will be described, referring to the block diagram illustrated in FIG. 13.

A CPU 1301 executes various processes using computer programs and data stored in a RAM 1302 or a ROM 1303. Accordingly, the CPU 1301 controls the operation of the computer apparatus as a whole, and executes or controls various processing operations described to be performed by the information processing apparatus.

The RAM 1302 includes an area for storing computer programs and data loaded from the ROM 1303 or an external storage apparatus 1306, or an area for storing data received from the outside via an I/F 1307. The RAM 1302 further includes a work area used when the CPU 1301 executes various processes. The RAM 1302 may thus provide various areas as appropriate.

The ROM 1303 has stored therein setting data of the computer apparatus, computer programs and data related to activation of the computer apparatus, computer programs and data related to basic operations of the computer apparatus, or the like.

An operation unit 1304, which is a user interface such as a keyboard, a mouse or a touch panel, can be operated by the user to input various instructions to the CPU 1301.

A display unit 1305, including a liquid crystal screen or a touch panel screen, can display results of processing by the CPU 1301 in the form of images, characters, or the like. Here, the display unit 1305 may be a projection apparatus such as a projector that projects images or characters.

An external storage apparatus 1306 is a large-capacity information storage apparatus such as a hard disk drive apparatus. The external storage apparatus 1306 has stored therein the OS, computer programs and data for causing the CPU 1301 to execute or control various processes described to be performed by the information processing apparatus. The computer programs and data stored in the external storage apparatus 1306 are loaded to the RAM 1302 as appropriate according to the control by the CPU 1301, which are then subjected to processing by the CPU 1301.

An I/F 1307 is a communication interface configured to conduct data communication with external apparatuses. For example, the I/F 1307 can have the image capturing unit 201 and the posture sensor 204, which have been described above, connected thereto. In such a case, the video captured by the image capturing unit 201 and the detected posture information detected by the posture sensor 204 are stored in the RAM 1302 or the external storage apparatus 1306 via the I/F 1307.

The CPU 1301, the RAM 1302, the ROM 1303, the operation unit 1304, the display unit 1305, the external storage apparatus 1306, and the I/F 1307 are all connected to a system bus 1308.

Here, the computer program described above may be of any form such as object codes, programs executed by an interpreter, script data supplied to the OS, or the like.

In addition, the storage media for providing such the computer program include the following media. For example, floppy (trade name) disk, hard disk, optical disk, magneto-optical disk, MO, CD-ROM, CD-R, CD-RW, magnetic tape, nonvolatile memory card, ROM, DVD (DVD-ROM, DVD-R), or the like.

In addition, the method of providing the computer program also include the following methods. Specifically, the methods includes connecting to a homepage on the Internet from a browser of a client computer, and downloading therefrom the computer program itself (or a compressed file including an automatic installation function) to a storage medium such as a hard disk. Alternatively, the methods can also be realized such that a program code forming the computer program is divided into a plurality of files and each of the files are downloaded from different homepages. In other words, a WWW server providing the download of the files of the computer program for a plurality of users is also included in the present disclosure.

In addition, the methods can also be realized such that the computer program is encrypted and stored in a storage medium such as CD-ROM, and then distributed to a user, and allow a user who has cleared a predetermined condition to download key information for decryption from a homepage via the Internet. In other words, the user uses the key information to execute the encrypted computer program and install it in a computer.

Alternatively, the numerical values, processing timings, processing orders, processing entities, and data (information) transmission destinations/transmission sources/storage locations, and the like used in the embodiments described above are referred to for specific description as an example, and are not intended for limitation to these examples.

Alternatively, some or all of the embodiments described above may be used in combination as appropriate. Further, some or all of the embodiments and modification examples described above may be used in a selective manner. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-166915, filed Oct. 11, 2021, which is hereby incorporated by reference herein in its entirety.

What is claimed is:

1. An information processing apparatus, comprising:
a storage control unit configured to convert information indicating an image capturing posture of a captured frame into posture information of posture expression without any discontinuity in posture change, and store compression encoded data of the frame and the posture information in a file.

2. The information processing apparatus according to claim 1, wherein, when posture information corresponding to a frame is acquired, the storage control unit stores information indicating the acquisition of the posture information corresponding to the frame and the posture information in the file.

3. The information processing apparatus according to claim 1, wherein, when posture information corresponding to a frame is not acquired, the storage control unit stores, in the file, the information indicating that the posture information corresponding to the frame is not acquired.

4. The information processing apparatus according to claim 1, wherein data length of the posture information is a data length corresponding to posture detection accuracy.

5. The information processing apparatus according to claim 1, wherein data length of the posture information is variable for each frame.

6. The information processing apparatus according to claim 1, wherein the storage control unit stores, in a file, an absolute value of posture information or a difference of posture information between frames.

7. The information processing apparatus according to claim 6, wherein the difference is data with fixed length.

8. The information processing apparatus according to claim 6, wherein the difference is data with variable length.

9. The information processing apparatus according to claim 1, wherein the storage control unit stores in the file, for a frame immediately after calibration of a sensor configured to detect the image capturing posture, an absolute value of posture information corresponding to the frame, and stores in the file, for a frame not immediately after calibration, a difference of posture information between frames.

10. The information processing apparatus according to claim 1, wherein the posture information is expressed by either a quaternion or a direction cosine matrix.

11. The information processing apparatus according to claim 1, wherein the file is an MP4 file formatted file.

12. The information processing apparatus according to claim 1, further comprising:
a sensor configured to detect the image capturing posture; and
an image capturing unit configured to capture the frame.

13. An information processing method, comprising:
converting information indicating an image capturing posture of a captured frame into posture information of posture expression without any discontinuity in posture change; and
storing compression encoded data of the frame and the posture information in a file.

14. A non-transitory computer-readable storage medium storing a computer program that causes a computer to execute an information processing method, the method comprising:
converting information indicating an image capturing posture of a captured frame into posture information of posture expression without any discontinuity in posture change; and
storing compression encoded data of the frame and the posture information in a file.
